(19) United States
(12) Patent Application Publication
(10) Pub. No.: US 2025/0297075 A1
(43) Pub. Date: Sep. 25, 2025

(54) Methods for Producing Porous Materials

(71) Applicant: Aspen Products Group, Inc., Marlborough, MA (US)

(72) Inventors: Mark Fokema, Northborough, MA (US); Decio Coutinho, Marlborough, MA (US)

(21) Appl. No.: 19/021,915

(22) Filed: Jan. 15, 2025

Related U.S. Application Data
(63) Continuation of application No. PCT/US25/11551, filed on Jan. 14, 2025.
(60) Provisional application No. 63/567,598, filed on Mar. 20, 2024.

(51) Int. Cl. C08J 9/28; C08J 9/00

(52) U.S. Cl. CPC C08J 9/28; C08J 9/0023; C08J 2301/02

(57) ABSTRACT

A porous material is manufactured from gel precursors, a solvent, and a drying agent. Initially, the drying agent, dissolved in a solvent, can replace a liquid that contains a porous three-dimensional solid network to form a drying-agent-solution-containing gel. Alternatively, the gel precursors can be cross-linked, with the drying agent included, in the initial charge to form the drying-agent-solution-containing gel. The drying-agent-solution-containing gel is heated to evaporate at least some of the solvent and to form a drying-agent-containing solid network, and then the drying-agent-containing solid network is heated to sublime the drying agent and to form a porous material.

### RELATED APPLICATIONS

This application is a continuation of International Application No. PCT/US25/11551, filed 14 Jan. 2025, the entire contents of which are incorporated herein by reference.

This application also claims the benefit of U.S. Provisional Application No. 63/567,598, filed 20 Mar. 2024, the entire content of which is incorporated herein by reference.

### GOVERNMENT SUPPORT

This invention was made with government support under award number DE-AR0001642 awarded by the Advanced Research Projects Agency-Energy (ARPA-E). The US government has certain rights in the invention.

### BACKGROUND

The present disclosure relates to systems and methods for preparing high porosity [e.g., at least 90 volume-% (vol %) void fraction) solids from liquid-containing gels. The high-porosity solids can be used, e.g., as thermal insulation, acoustic insulation, impact dampers, catalysts, adsorbents, desiccants, sensors, electrodes, and lightweight structural elements.

Gels are a diverse class of materials comprised of three-dimensional networks of solid materials that contain fluid-filled pores and are characterized by a low solids fraction—typically less than 10 vol %. Wet gels may contain liquids, such as water (hydrogels), alcohol (alcogels), or other solvents (solvogels). The pores of wet gels are typically smaller than 10 microns in dimension and retain the liquid phase through capillary forces. Dried gels, commonly referred to as aerogels, cryogels, or xerogels, have pore structures similar to that of wet gels; but the pores are filled with gases—most often air. The low density (e.g., less than 0.2 g/cm³) and small pore size (e.g., less than 10 microns) of dried gels make them well-suited for use, e.g., as thermal insulation, acoustic insulation, impact dampers, catalysts, adsorbents, desiccants, sensors, electrodes, and lightweight structural elements.

Dried gels are commonly produced from wet gels through the displacement of the pore liquid with a gas—otherwise referred to as drying. However, retention of the porosity of the wet gel throughout the drying process is challenging due to capillary forces that arise within the pores during the liquid removal process. These capillary forces acting along the meniscus between the liquid and gas phases often exceed the strength of the pore walls, leading to structural collapse of the pores and loss of porosity in the dried material.

The capillary forces acting on pore walls during drying can be estimated by the Young-Laplace equation that relates the capillary force to the pore dimension, interfacial tension, and contact angle of the liquid to the solid phase. Common strategies for minimizing pore collapse during gel drying include reducing the liquid surface tension, modifying the contact angle of the liquid to the solid to near 90 degrees, enlarging the pore dimension, or avoiding the formation of a liquid-gas interface.

Liquid removal from the pores of wet gels without forming a liquid-gas interface may be accomplished by converting the liquid into a supercritical fluid, followed by venting the supercritical fluid from the pores of the gel. Under supercritical conditions, the distinction between liquid and gas phases is lost, with both phases coalescing into a single supercritical fluid state in which there is no liquid-gas interfacial tension and thus no capillary forces exerted upon the pores of the gel. Dried gels produced by supercritical drying methods are commonly called aerogels, which are solids typically characterized by low density (e.g., less than 0.2 g/cm³) and small pore dimensions (e.g., less than 1 micron). This drying approach is often used for the commercial production of aerogel products (e.g., aerogel insulation from Aspen Aerogels, Inc.), but the cost associated with supercritical processing is a drawback.

In order for a fluid to enter the supercritical state, conditions must exceed the supercritical point of the fluid. The supercritical point of many of the solvents used to prepare wet gels are well above ambient pressure and temperature [e.g., water (22.1 MPa, 374° C.), ethanol (6.1 MPa, 241° C.)], necessitating the use of high-pressure containment vessels (autoclaves) capable of operating at above ambient temperatures to dry the gels. Alternatively, the fluid within the pores of the wet gel can be exchanged with another fluid with more favorable supercritical properties [e.g., carbon dioxide (7.4 MPa, 31° C.)] in order to reduce the severity of the conditions required to conduct supercritical drying. While the use of a fluid such as carbon dioxide reduces the drying temperature and eliminates flammability concerns associated with the use of organic solvents at above ambient temperature, a high-pressure vessel is still used for drying, which represents a significant capital cost and presents a limitation on the dimensions of gels that can be supercritically dried. Additionally, supercritical CO₂ drying typically requires that the liquid used to form the wet gel be replaced with liquid CO₂ via a repetitive solvent exchange process in which liquid CO₂ diffuses into the pores of the gel as the liquid diffuses out of the pores of the gel. The solvent exchange process is time-consuming and often conducted in a pressure vessel, thus further contributing to the high energy consumption and high cost of the supercritical drying process.

Liquid removal from the pores of wet gels without the formation of a liquid-gas interface may also be accomplished by converting the liquid into a solid phase followed by sublimation of the solid phase from the pores of the gel, a process also known as freeze-drying, lyophilization, or cryodessication. Dried gels produced by this method are commonly called cryogels because they are often produced at temperatures below ambient. Cryogels, like aerogels, are solids typically characterized by low density (e.g., less than 0.2 g/mL) and small pore dimensions (e.g., less than 1 micron). This drying approach is sometimes used for the commercial production of aerogel products (e.g., those from Aerogel Technologies, LLC), but the time required to accomplish complete sublimation of the solid phase is a drawback.

Drawbacks to the use of freeze-drying methods to produce high-porosity solids from liquid-containing gels include cooling the wet gel to below ambient temperature in order to solidify the liquid contained in its pores, the potentially destructive effects of crystal formation on pore structure during freezing, the slow rate of sublimation of the frozen liquid from the pores of the gel, and the practice of maintaining a low fluid partial pressure surrounding the gel, typically through the use of vacuum equipment. These drawbacks result in cryogel production being characterized by low throughput, high energy consumption, and thus high processing costs.

The versatility of water as a solvent for wet gel formation (e.g., formation of a hydrogel) has prompted extensive investigation and the use of water as the solidified liquid for cryogel production. However, water freezes in a highly anisotropic manner, often resulting in the formation of anisotropic ice crystals that can disrupt or template the structure of the solid phase of the wet gel. This is the principle behind the process of freeze-casting (or ice-templating or directional freezing), which can be used to produce porous materials with unique and anisotropic pore structures. When applied to a hydrogel, the solid matrix is often displaced by the ice crystals, resulting in the formation of denser envelopes surrounding the crystals and, following freeze-drying, the production of a porous material with large (e.g., greater than 10 microns) anisotropic pores surrounded by a locally denser solid network. The templating behavior of ice crystals can be reduced by rapidly freezing the hydrogel (e.g., in a cryogenic fluid such as liquid nitrogen) in order to promote crystal nucleation and to reduce or minimize crystal growth.

Preservation of the nanoporous pore structure of wet gels during freeze drying can be accomplished through the use of solvents other than water—either by directly forming the gel with the solvent (solvogel) or by exchanging the water in a hydrogel with the solvent to form a solvogel in a repetitive solvent-exchange process. Tert-butanol is a commonly employed solvent for this purpose, as it is miscible with water, which facilitates solvent exchange, forms weaker crystals than does water, which reduces templating effects, has a freezing point of 26° C., which reduces the energy required to cool the wet gel in order to freeze the liquid, and has a higher vapor pressure (6 kPa) at its freezing point than does water (0.6 kPa), which enables more rapid sublimation of the frozen liquid during freeze-drying. Unfortunately, residual water (e.g., greater than 0.5 vol %) in tert-butanol gels and the confinement of solvent in small pores can lower the freezing point of the liquid to well below ambient temperature, which involves the use of cooling equipment; and tert-butanol removal is typically conducted in a pressure vessel with vacuum equipment used to maintain the freeze-dryer pressure below the vapor pressure of tert-butanol (<6 kPa). While tert-butanol removal can be accomplished at ambient pressure using a high purge rate of gas to maintain the partial pressure of tert-butanol surrounding the gel below the vapor pressure of tert-butanol (<6 kPa), recovery of tert-butanol from the dilute exhaust stream for reuse can be energy-intensive.

Dried gels produced from wet gels by drying processes that involve liquid-gas interfaces and that operate at ambient pressure are often referred to as xerogels, which have characteristics similar to aerogels. Preservation of the wet-gel pore structure in xerogels is commonly accomplished by manipulating other variables in the Young-Laplace equation, namely by reducing the surface tension of the liquid, chemically modifying the solid surface to alter the liquid contact angle, or simply increasing the strength of the pore walls so that they are able to withstand the capillary pressure without loss of pore integrity. This drying approach is also used for the commercial production of aerogel products (e.g., those from Cabot Corporation), but the capillary forces incident on pore walls during drying inevitably result in some degradation of the pore structure that may adversely impact product properties.

Xerogel production processes can employ a variety of strategies to reduce capillary stress on the pore walls of the gel. Solvent exchange with low-surface-tension solvents, such as perfluoroheptane, pentane, ethyl ether, hexane, heptane, isooctane, acetonitrile, and methyl tert-butyl ether, among others, is a common approach. Drying at elevated temperatures or the use of surfactants may also reduce surface tension. The contact angle of the solvent to the wet gel pore wall can be changed by modifying the wet gel with hydrophobic, hydrophilic, or other surface-modifying species. For instance, modifiers, such as siloxanes (e.g., hexamethyldisiloxane), silazanes (e.g., hexamethyldisilazane), chlorosilanes (e.g., trimethylchlorosilane), and alkoxysilanes (e.g., trimethylmethoxysilane), are commonly employed to increase the hydrophobicity of gel surfaces. Species such as these can also thicken the pore wall, thereby providing added strength to the pore to resist collapse due to capillary forces during drying. However, all of these approaches add time and cost to the process of removing liquid from the wet gel or result in materials of higher solids density than the wet gel.

Systems and methods that facilitate liquid removal from wet gels at ambient or near-ambient pressure to produce dried materials with a gel-like structure in which the porosity of the wet gel is preserved in the dried gel offer the potential for rapid and inexpensive production of, e.g., micro- and meso-porous materials suitable for a wide range of applications.

### SUMMARY

Described herein are systems and methods that effect liquid removal from wet gels and other wet precipitates without freeze drying or supercritical processing.

A method for manufacturing a porous material includes forming a drying-agent-solution-containing gel, comprising a solvent, a drying agent dissolved in the solvent, and a porous three-dimensional solid network contained in the solvent. The drying-agent-solution-containing gel is formed by one of two alternative methods. In a first method, a gel comprising a liquid containing the porous three-dimensional solid network is introduced as an initial charge. At least some of the liquid contained in pores of the porous three-dimensional solid network is then replaced with a drying agent dissolved in a solvent to form the drying-agent-solution-containing gel. In a second method, gel precursors, the solvent, and the drying agent are introduced as an initial charge; and a crosslinking of the gel precursors is initiated to produce the porous three-dimensional solid network and to form the drying-agent-solution-containing gel. The drying-agent-solution-containing gel is then heated to evaporate at least some of the solvent and to form a drying-agent-containing solid network, and then the drying-agent-containing solid network is heated to sublime the drying agent and to form a porous material.

The drying agent can sublime from the gel structure at atmospheric or otherwise ambient pressure and ambient or above-ambient temperature. This use of a drying agent enables the rapid and energy-efficient production of porous dried gels with dimensions not limited by the dimensions of heavy-walled pressure vessels or vacuum chambers.

In various exemplifications, the drying agent is characterized by being a solid at ambient temperature and pressure, possessing a high vapor pressure, possessing a high melting-point temperature, and being soluble in the liquid contained in the pores of the gel. In various exemplifications, the drying agent is camphene; 1,2,4,5-tetramethylbenzene; naphthalene; 2,2,3,3-tetramethylbutane; p-benzoquinone; dimethyl benzene-1,4-dicarboxylate; hexamethylbenzene; hydroquinone; camphor; tetrachloro-p-benzoquinone; hexamethylenetetramine; other organic compounds; or mixtures thereof.

The dried porous material can be employed in a variety of applications, including, e.g., thermal insulation, acoustic insulation, impact dampers, catalysts, adsorbents, desiccants, sensors, electrodes, and lightweight structural elements.

In particular embodiments, the dried porous materials are directed to thermal-insulation applications, as the porous structure of the material inhibits the transfer of heat via conductive, convective, and radiative mechanisms. The dried high-porosity materials can have a thermal conductivity of less than 35 mW/mK, less than 30 mW/mK, less than 25 mW/mK, less than 20 mW/mK, or even less than 15 mW/mK at 25° C. The dried high-porosity materials can be employed to reduce heat loss from buildings, appliances, automobiles, aircraft, marine vessels, shipping containers, electronic devices, and industrial equipment.

The methods described for manufacturing a high-porosity material can be used to produce a variety of dried materials for a variety of applications. The methods described herein can overcome numerous shortcomings associated with the traditional production of high-porosity materials via supercritical-, freeze-, and ambient-pressure drying, including (1) loss of pore volume, (2) loss of surface area, (3) rearrangement of pore structure, (4) long-processing time, (5) high-pressure operation, (6) low-temperature operation, (7) batch processing, and (8) high cost. These and other advantages and attainments of embodiments of the present invention will become apparent to those skilled in the art upon a reading of the following detailed description and illustrative embodiments of the invention.

### BRIEF DESCRIPTION OF THE DRAWINGS

In the course of the following detailed description, reference will be made to the attached drawings in which:

FIG. 1 is a schematic representation of a gel being dried to form a porous material.

FIG. 2 is a schematic representation of a drying-agent-containing solid network during drying.

FIG. 3 is a schematic representation of a water-containing gel being dried to form a porous material.

FIG. 4 is a schematic representation of an exemplary system in which a continuous drying process is performed.

FIG. 5 is a magnified photographic image of an exemplification of a high-porosity material microstructure.

FIG. 6 is a magnified photographic image of an exemplification of a high-porosity material microstructure.

FIG. 7 is a magnified photographic image of an exemplification of a high-porosity material microstructure.

FIG. 8 is a magnified photographic image of an exemplification of a high-porosity material microstructure.

The drawings are not necessarily to scale; instead, an emphasis is placed upon illustrating particular principles in the exemplifications discussed below.

### DETAILED DESCRIPTION

The foregoing and other features and advantages of various aspects of the invention(s) will be apparent from the following more particular description of various concepts and specific embodiments within the broader bounds of the invention(s). Various aspects of the subject matter introduced above and discussed in greater detail below may be implemented in any of numerous ways, as the subject matter is not limited to any particular manner of implementation. Examples of specific implementations and applications are provided primarily for illustrative purposes.

Unless otherwise herein defined, used, or characterized, terms that are used herein (including technical and scientific terms) are to be interpreted as having a meaning that is consistent with their accepted meaning in the context of the relevant art and are not to be interpreted in an idealized or overly formal sense unless expressly so defined herein. For example, if a particular composition is referenced, the composition may be substantially (though not perfectly) pure, as practical and imperfect realities may apply; e.g., the potential presence of at least trace impurities (e.g., at less than 1 or 2%) can be understood as being within the scope of the description. Likewise, if a particular shape is referenced, the shape is intended to include imperfect variations from ideal shapes, e.g., due to manufacturing tolerances. Percentages or concentrations expressed herein can be in terms of weight or volume. Processes, procedures, and phenomena described below can occur at ambient pressure (e.g., about 50-120 kPa—for example, about 90-110 kPa) and temperature (e.g., −20 to 50° C.—for example, about 10-35° C.) unless otherwise specified.

Although the terms, first, second, third, etc., may be used herein to describe various elements, these elements are not to be limited by these terms. These terms are simply used to distinguish one element from another. Thus, a first element, discussed below, could be termed a second element without departing from the teachings of the exemplary embodiments.

Spatially relative terms, such as “above,” “below,” “left,” “right,” “in front,” “behind,” and the like, may be used herein for ease of description to describe the relationship of one element to another element, as illustrated in the figures. It will be understood that the spatially relative terms, as well as the illustrated configurations, are intended to encompass different orientations of the apparatus in use or operation in addition to the orientations described herein and depicted in the figures. For example, if the apparatus in the figures is turned over, elements described as “below” or “beneath” other elements or features would then be oriented “above” the other elements or features. Thus, the exemplary term, “above,” may encompass both an orientation of above and below. The apparatus may be otherwise oriented (e.g., rotated 90 degrees or at other orientations), and the spatially relative descriptors used herein are to be interpreted accordingly. The term, “about,” can mean within ±5% or ±10% of the value recited. In addition, where a range of values is provided, each subrange and each individual value between the upper and lower ends of the range is contemplated and, therefore, disclosed.

Further still, in this disclosure, when an element is referred to as being “on,” “connected to,” “coupled to,” “in contact with,” etc., another element, it may be directly on, connected to, coupled to, or in contact with the other element or intervening elements may be present unless otherwise specified.

The terminology used herein to describe particular embodiments is not intended to limit the represented concepts to the particulars of the exemplary embodiments. As used herein, singular forms, such as “a” and “an,” are intended to include the plural forms as well unless the context indicates otherwise. Additionally, the terms, “includes,” “including,” “comprises,” and “comprising,” specify the presence of the stated elements or steps but do not preclude the presence or addition of one or more other elements or steps.

The term, “gel,” is used herein to designate a three-dimensional network of solid material that contains fluid-filled pores and is characterized by a low solids fraction—typically less than 10 vol %.

The term, “aerogel,” is used herein to designate a dry, porous, nanostructured material in which the pores primarily have widths of less than 1 micron. While aerogels are most commonly produced by supercritical processes, other methods, such as freeze drying, may also be used to produce materials commonly referred to as aerogels.

The term, “xerogel,” is used herein to designate a dry, porous, nanostructured material in which the pores primarily have widths of less than 1 micron and that is typically produced via solvent removal at ambient-pressure processing conditions.

The term, “solvent,” is used herein to designate an organic liquid that dissolves a solute to form a solution.

The term, “drying agent,” is used herein to designate a compound that is soluble in the solvent contained in the pores of the gel and that can be precipitated and sublimed from the pores.

The term, “drying-agent-containing solid network,” is used herein to designate a three-dimensional network of solid material that defines pores that contain solid drying agent and is characterized by a high drying agent fraction—typically greater than 90 vol %.

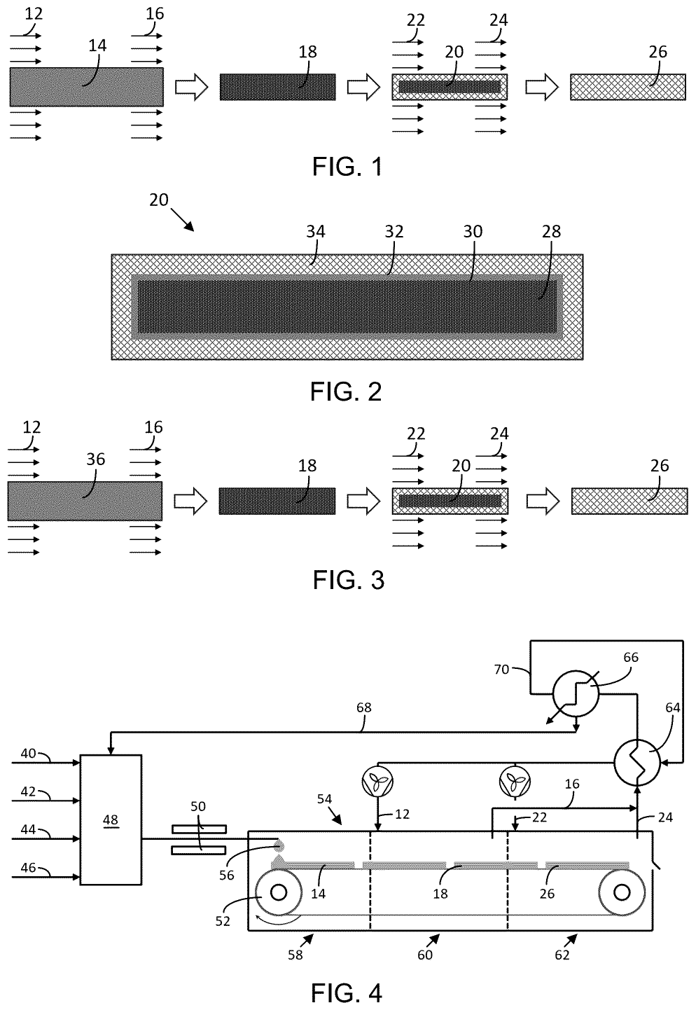

Now, referring to FIGS. 1-8, features and details of systems and methods of producing porous materials are described. Particular embodiments are detailed below for the purpose of illustration and not as limitations of the invention.

### Porous Material Preparation From Gel

FIG. 1 is a representation of an exemplary process that can be employed to produce the porous material. In the first stage of the process, a first purge gas 12 is introduced over the surface of a gel 14 that has pores filled with a drying agent dissolved in a solvent. Evaporation of the solvent from the surface of the gel 14 increases the solvent concentration in the withdrawn purge gas 16 and reduces the amount of solvent located at the surface of the gel. Solvent from the interior of the gel diffuses to the surface of the gel to replenish the evaporated solvent and to reduce or minimize the solvent concentration gradient within the gel. Solvent diffusion and evaporation result in an increase in the concentration of the drying agent within the solvent contained in the pores of the gel. The concentration of the drying agent in the solvent increases until the solvent becomes saturated with the drying agent, at which time the drying agent begins to precipitate and solidify within the pores of the gel.

Evaporation of the solvent into the first purge gas 12 continues, typically until greater than about 60%—e.g., greater than about 70%, greater than about 80%, greater than about 90%, greater than about 95%, or, in more-particular embodiments, at least about 98% of solvent has evaporated from the gel and typically until greater than about 60%—e.g., greater than about 70%, greater than about 80%, greater than about 90%, greater than about 95%, and, in more-particular embodiments, at least about 98% of drying agent has precipitated and solidified within the pores of the gel to yield a drying-agent-containing solid network 18.

While evaporating as much solvent as possible during the formation of the drying-agent-containing solid network can be advantageous, in other embodiments, it can be faster and more cost-effective to evaporate less of the solvent during the formation of the drying-agent-containing solid network and to evaporate more of the solvent in the second stage of the process. In these embodiments, evaporation of the solvent into the first purge gas 12 continues, typically until less than about 98%—e.g., less than about 95%, less than about 90%, less than about 80%, less than about 70%, or in more-particular embodiments, at most about 60% of solvent has evaporated from the gel.

Solvent evaporation from the gel 14 is conducted at a temperature below the melting-point temperature of the drying agent but at a temperature high enough to promote rapid diffusion and evaporation of the solvent from the gel. Solvent diffusion and evaporation are typically completed in less than about 48 hours—e.g., less than about 24 hours, less than about 12 hours, less than about 6 hours, less than about 2 hours, less than about 1 hour, less than about 30 minutes, less than about 10 minutes, or, in more particular embodiments, at most about 2 minutes. The solvent-evaporation temperature is typically greater than about 30° C. below the boiling-point temperature of the solvent—e.g., greater than about 15° C. below the boiling-point temperature of the solvent, greater than about the boiling-point temperature of the solvent, greater than about 15° C. above the boiling-point temperature of the solvent, greater than about 30° C. above the boiling-point temperature of the solvent, or, in more-particular embodiments, at least about 45° C. above the boiling point of the solvent. Depending upon the solvent, the solvent evaporation temperature is typically greater than about 70° C.—e.g., greater than about 80° C., greater than about 90° C., greater than about 100° C., greater than about 110° C., greater than about 130° C., greater than about 150° C., or, in more-particular embodiments, at least about 170° C.

Solvent diffusion and evaporation can be conducted at ambient pressure to avoid the use of a containment vessel for the gel 14 but may also be conducted at pressures above or below ambient pressure to affect the boiling-point temperature of the solvent if desired.

Solvent diffusion and evaporation result in shrinkage of the gel 14, such that the volume of the drying-agent-containing solid network 18 is lower than that of the gel 14. The amount of shrinkage is related to the concentration of solvent in the gel 14 and to the percentage of solvent evaporated from the gel prior to the formation of the drying-agent-containing solid network 18. Gel shrinkage is typically less than about 50 volume percent—e.g., less than about 35 volume percent, less than about 20 volume percent, less than about 10 volume percent, or, in more particular embodiments, at most 5 volume percent.

The energy required to effect solvent evaporation may be delivered to the gel 14 via a variety of mechanisms, including conduction from the surface upon which the gel 14 is supported, convection from the first purge gas 12, and/or radiation from the environment surrounding the gel 14. Microwave radiation may also be used to heat the gel and effect solvent evaporation.

The first purge gas 12 can be any gas suitable for convecting thermal energy to the surface of the gel 14, carrying away solvent from the surface of the gel 14, and from which the solvent can later be recovered from the withdrawn purge gas 16 for solvent reuse. The first purge gas 12 can flow over the gel 14 in any orientation, but flow in a direction perpendicular to the smallest dimension of the gel may be preferred to promote uniform removal of solvent from the gel surface. The first purge gas 12 can be flowed at any rate, but a flow rate such that the withdrawn purge gas 16 is nearly saturated in solvent vapor makes subsequent recovery of solvent from the withdrawn purge gas 16 easier.

The first purge gas 12 may comprise air, nitrogen, helium, argon, carbon dioxide, other common gases, or mixtures thereof. To avoid condensation and diffusion of water into the gel 14 and to reduce or minimize contamination of the withdrawn purge gas 16 with water, the water vapor content of the first purge gas 12 is typically less than about 2 volume percent—e.g., less than about 1 volume percent, less than about 0.5 volume percent, or, in more-particular embodiments, at most 0.2 volume percent.

To reduce or minimize losses of the drying agent to the first purge gas 12 that would reduce the amount of drying agent retained in the drying-agent-containing solid network 18, the first purge gas 12 may be pre-saturated with the drying agent such that the partial pressure of the drying agent in the first purge gas 12 is similar to the vapor pressure of the drying agent at the surface of the gel 14. Pre-saturation of the first purge gas 12 with the drying agent can be accomplished by flowing the first purge gas 12 through a vessel containing the drying agent at a temperature similar to that at which solvent diffusion and evaporation occur.

In another exemplification, saturation of the first purge gas 12 with the drying agent is realized by reducing the flow rate of the first purge gas 12 such that a small portion of drying agent from the gel 14 sublimes into the first purge gas 12 to saturate the first purge gas 12 and to inhibit additional sublimation of the drying agent from the gel 14.

In another exemplification, solvent is evaporated from the gel 14 in the absence of a purge gas. In this exemplification, the gel is retained in a chamber that maintains a saturated atmosphere of drying-agent vapor that arises from the sublimation of a small portion of the drying agent from the gel 14 and inhibits additional sublimation of the drying agent from the gel 14. The vapor pressure of the solvent is substantially higher than that of the drying agent and can continuously evaporate from the gel 14, even in an unpurged chamber, if the vapor pressure of the solvent is greater than the partial pressure of solvent in the chamber. In this exemplification, the withdrawn purge gas 16 comprises primarily solvent vapor with a small amount of drying agent vapor.

In yet another exemplification, loss of the drying agent from the gel 14 during solvent evaporation is reduced by locating the gel 14 adjacent to a reservoir of drying agent so that a portion of the drying agent in the withdrawn purge gas 16 arises from the drying agent in the reservoir and a portion arises from the drying agent contained in the gel 14.

Referring again to FIG. 1, in the second stage of the process, a second purge gas 22 is introduced over the surface of a drying-agent-containing solid network 18 to form a drying gel 20; a drying-agent-containing purge gas 24; and ultimately, upon complete removal of the drying agent, a porous material 26. Sublimation of the solidified drying agent contained within the drying-agent-containing solid network 18 has minimal effects on the solid pore structure of the drying-agent-containing solid network 18, as there is no liquid-gas meniscus present to exert capillary forces on the pore walls during drying agent removal. This stage of gel drying is similar in nature to what occurs during a conventional freeze-drying process; however, the drying agent, temperature, pressure, and rate of drying agent removal may be substantially different than a conventional freeze-drying process.

Sublimation of the drying agent from the drying gel 20 begins at the surface of the drying gel 20, with sublimation proceeding inwards towards the center of the gel as the drying agent is removed from the exterior pores of the drying gel 20 via sublimation. Residual amounts of solvent still retained in the drying-agent-containing solid network 18 may also be removed from the drying gel 20 during this stage of drying, with solvent evaporation occurring simultaneously with drying-agent sublimation. FIG. 2 depicts a scheme in which residual solvent 28 contained in the gel may be removed from the drying gel 20 in an evaporation front 30 that precedes the sublimation front 32, thereby yielding a penetrating shell of solid drying agent at the interface between the dried gel 34 and the drying-agent-containing portion of the gel. Evaporation of liquid in advance of sublimation of the drying agent ensures that pores that contain liquid also contain drying agent. Without wishing to be bound by any particular theory, the presence of the drying agent in a pore from which liquid is evaporating either disrupts the liquid/purge-gas meniscus and reduces the capillary force on the pore wall, or the drying agent fills the pore sufficiently to provide structural support to resist pore collapse upon exposure of the pore wall to capillary forces.

The drying-agent sublimation temperature is typically at least equivalent to the solvent-evaporation temperature—e.g., greater than about 10° C. above the solvent-evaporation temperature, greater than about 20° C. above the solvent-evaporation temperature, greater than about 30° C. above the solvent-evaporation temperature, greater than about 50° C. above the solvent-evaporation temperature, or, in more-particular embodiments, greater than about 70° C. above the solvent-evaporation temperature. Depending upon the drying agent, the drying-agent sublimation temperature is typically greater than about 75° C.—e.g., greater than about 90° C., greater than about 110° C., greater than about 130° C., greater than about 150° C., or, in more particular embodiments, at least about 170° C.

The energy required to effect drying-agent sublimation can be delivered to the drying gel 20 via a variety of mechanisms, including conduction from the surface upon which the drying gel 20 is supported, convection from the second purge gas 22, and/or radiation from the environment surrounding the drying gel 20. Microwave radiation can also be used to heat the drying gel 20 and effect drying-agent sublimation.

The second purge gas 22 can be any gas suitable for convecting thermal energy to the surface of the drying gel 20, carrying away the drying agent from the drying gel 20, and from which the drying agent can later be recovered from the drying-agent-containing purge gas 24 for drying-agent reuse. The second purge gas 22 can flow over the drying gel 20 in any orientation, but flow in a direction perpendicular to the smallest dimension of the drying gel 20 may be advantageous to promote uniform removal of drying agent from the drying gel 20. Second purge gas 22 can be flowed at any rate, but a flow rate such that the drying-agent-containing purge gas 24 is nearly saturated in drying-agent vapor makes subsequent recovery of drying agent from the drying-agent-containing purge gas 24 easier.

The second purge gas 22 can comprise air, nitrogen, helium, argon, carbon dioxide, other common gases, or mixtures thereof. To avoid condensation and diffusion of water into the drying gel 20 and to reduce or minimize contamination of the drying-agent-containing purge gas 24 with water, the water-vapor content of the second purge gas 22 is typically less than about 2 volume percent—e.g., less than about 1 volume percent, less than about 0.5 volume percent, or, in more-particular embodiments, at most 0.2 volume percent.

In an alternative embodiment, the drying agent is sublimed from the drying gel 20 in the absence of a purge gas. In this embodiment, the drying gel 20 is retained in a loosely sealed chamber that has walls that are at a lower temperature than the drying gel 20. Drying agent sublimes from the drying gel 20 and deposits on the surface of the cooler chamber wall, thereby maintaining a drying-agent partial pressure within the chamber that is lower than the drying-agent vapor pressure at the drying gel 20 surface and facilitating the complete transfer of the drying agent from the drying gel 20 to the walls of the chamber in the absence of a purge gas.

The composition of the drying agent is dependent upon the solids composition of the gel, the composition of the solvent contained in the pores of the gel, and the temperatures at which the gel is dried. The drying agent can exhibit specific physical characteristics. It is advantageous for the drying agent to possess a high melting-point temperature (e.g., above the temperature used to sublime drying agent from the drying-agent-containing solid network 18), to possess a low vapor pressure at the temperature used to evaporate solvent from the gel 14, to possess a high vapor pressure at the temperature used to sublime drying agent from the drying-agent-containing solid network 18, to be highly-soluble in a solvent contained in the pores of the gel 14, and to form amorphous or weakly crystalline structures upon precipitation from the solvent.

To ensure that the drying agent does not melt during the drying process and thereby subject the pores of the drying-agent-containing solid network 18 to undesirable capillary forces, the melting-point temperature of the drying agent is typically greater than about 30° C.—e.g., greater than about 70° C., greater than about 110° C., greater than about 150° C., or in more-particular embodiments, greater than about 190° C.

To reduce or minimize loss of drying agent during solvent evaporation, the vapor pressure of the drying agent is typically less than about 20 kPa at 50° C.—e.g., less than about 5 kPa at 50° C., less than about 1 kPa at 50° C., less than about 0.2 kPa at 50° C., less than about 0.05 kPa at 50° C., or in more-particular embodiments, less than about 0.01 kPa at 50° C.

To provide rapid removal of drying agent during drying-agent sublimation, the vapor pressure of the drying agent is typically greater than about 0.01 kPa at 100° C.—e.g., greater than about 0.1 kPa at 100° C., greater than about 1 kPa at 100° C., greater than about 10 kPa at 100° C., or in more-particular embodiments, greater than about 100 kPa at 100° C. Drying agent sublimation is typically completed in less than about 48 hours—e.g., less than about 24 hours, less than about 12 hours, less than about 6 hours, less than about 2 hours, less than about 1 hour, less than about 30 minutes, less than about 10 minutes, or, in more-particular embodiments, at most about 2 minutes.

To reduce or minimize gel shrinkage during solvent evaporation, the solubility of the drying agent in a solvent can be greater than about 30 weight percent—e.g., greater than about 40 weight percent, greater than about 50 weight percent, greater than about 60 weight percent, greater than about 70 weight percent, or in more-particular embodiments, even greater than 80 weight percent at 25° C.

In various exemplifications, the drying agent is camphene; 1,2,4,5-tetramethylbenzene, naphthalene; 2,2,3,3-tetramethylbutane; p-benzoquinone; dimethyl benzene-1,4-dicarboxylate; hexamethylbenzene; hydroquinone; camphor; tetrachloro-p-benzoquinone; hexamethylenetetramine; other organic compounds; or mixtures thereof.

The composition of the solvent is dependent upon the solids composition of the gel, the composition of the drying agent, and the temperatures at which the gel is dried. The solvent can exhibit specific physical characteristics. It is advantageous for the solvent to possess a low boiling-point temperature (e.g., below the melting-point temperature of the drying agent), to possess a high vapor pressure at the temperature used to evaporate solvent from the gel, to exhibit high solvency for the drying agent, to exhibit no solvency for the solid component of the gel, to exhibit low surface tension, to exhibit high diffusivity within a solid matrix of the drying agent, and to promote the formation of amorphous or weakly crystalline structures upon drying-agent precipitation.

To provide rapid evaporation of the solvent during the first stage of the process, the boiling-point temperature of the solvent is typically less than about 175° C.—e.g., less than about 150° C., less than about 125° C., less than about 100° C., less than about 75° C., or in more-particular embodiments, less than about 50° C.

To provide rapid evaporation of the solvent during the first stage of the drying process, the vapor pressure of the solvent is typically greater than about 0.01 kPa at 50° C.—e.g., greater than about 0.1 kPa at 50° C., greater than about 1 kPa at 50° C., greater than about 10 kPa at 50° C., or in more-particular embodiments, greater than about 50 kPa at 50° C.

To reduce or minimize gel shrinkage during solvent evaporation, the solubility of the drying agent in a solvent can be greater than about 30 weight percent—e.g., greater than about 40 weight percent, greater than about 50 weight percent, greater than about 60 weight percent, greater than about 70 weight percent, or in more-particular embodiments, even greater than 80 weight percent at 25° C.

To reduce or minimize capillary forces on the pores of the gel during the process, the surface tension of the solvent can be less than about 40 mN/m—e.g., less than about 30 mN/m, less than about 25 mN/m, less than about 20 mN/m), or in more-particular embodiments, even less than 18 mN/m at 25° C.

In various exemplifications, the solvent is an alcohol, such as methanol, ethanol, 1-propanol, 2-propanol, 1-butanol, 2-butanol, 2-methylbutan-2-ol, 2-methoxyethanol, 2-ethoxyethanol, 2-propoxyethanol, 2-isopropoxyethanol, 1-methoxy-2-propanol, 3-methoxy-1-propanol, 1-ethoxy-2-propanol, or 3-ethoxy-1-propanol; a ketone, such as acetone, butanone, 2-pentanone, or 3-pentanone; 1,1-dimethoxyethane; 1,2-dimethoxyethane; dimethylformamide; pyridine; acetonitrile; tetrahydrofuran; diethylether; methyl tert-butylether; or mixtures thereof.

In some embodiments, suitable solid materials that comprise the solid phase of the gel include silica, an organically modified silica (ormosil), a biopolymer, a polysaccharide, a cellulose, an alginate, a carrageenan, an agarose, a starch, a chitin, a chitosan, a gelatin, a pectin, a phenolic polymer, a resorcinol-formaldehyde polymer, a polyimide, a polyamide, a polyurea, a polyurethane, a polyisocyanate, a polyisocyanurate, a polyacrylonitrile, or mixtures thereof.

In some embodiments, the gel can be reinforced with a fiber comprising glass; carbon; a biopolymer (e.g., cellulose, chitin, viscose, or wool); a polymer (e.g., polyamide, polyethylene, polypropylene, polyurethane, polyacrylonitrile, polyethylene terephthalate, or polybutylene terephthalate); a ceramic (e.g., silica, alumina, or zirconia); or mixtures thereof.

### Gel Preparation

The preparation of a gel 14 having pores that are filled with a drying agent dissolved in a solvent can be achieved in a variety of ways.

In one exemplification, the gel 14 that contains drying agent dissolved in solvent can be prepared via solvent exchange of a hydrogel, alcogel, or solvogel. The hydrogel, alcogel, or solvogel can be prepared via a variety of methods, including a sol-gel process in which precursors, such as monomers, fine solid particles, or fibers, are dissolved, dispersed, or suspended in a continuous liquid medium and are caused to crosslink or interconnect (e.g., through ionic bonding, covalent bonding, hydrogen bonding, or other mechanisms) to form a 3-dimensional network of solids within the liquid medium. The hydrogel, alcogel, or solvogel is typically prepared at greater than about 10° C.—e.g., greater than about 20° C., greater than about 40° C., greater than about 60° C., or in more-particular embodiments, greater than about 80° C. In this embodiment the hydrogel, alcogel, or solvogel is brought into contact with a drying agent dissolved in a solvent or a drying agent dissolved in a sequence of solvents to effect replacement of typically greater than about 60%—e.g., greater than about 70%, greater than about 80%, greater than about 90%, greater than about 95%, or in more-particular embodiments, at least about 98% of the liquid in the hydrogel, alcogel, or solvogel with the drying agent and solvent via diffusive exchange.

While replacing as much liquid as possible during solvent exchange of the hydrogel, alcogel, or solvogel can be advantageous, in other embodiments, it can be faster and more cost-effective to replace less of the liquid during solvent exchange and to evaporate more of the liquid during the formation of the drying-agent-containing solid network and during sublimation of the drying agent. In these embodiments, less than typically about 98%—e.g., less than about 95%, less than about 90%, less than about 80%, less than about 70%, or in more-particular embodiments, at most about 60% of the liquid is replaced; and at least some of the remaining liquid is evaporated when the drying-agent-solution-containing gel is then heated.

In another exemplification, the gel 14 containing drying agent dissolved in solvent can be prepared via solvent exchange of the hydrogel, alcogel, or solvogel with solvent to effect replacement of typically greater than about 60%—e.g., greater than about 70%, greater than about 80%, greater than about 90%, or in more-particular embodiments, greater than about 95% of the liquid in the hydrogel, alcogel, or solvogel followed by dispersion of solid drying agent on the surface of the exchanged hydrogel, alcogel, or solvogel.

In particular embodiments, less than typically about 98%—e.g., less than about 95%, less than about 90%, less than about 80%, less than about 70%, or in more-particular embodiments, at most about 60% of the liquid is replaced, followed by dispersion of solid drying agent on the surface of the exchanged hydrogel, alcogel, or solvogel. The solid drying agent dissolves and diffuses into the solvent contained in the pores of the exchanged hydrogel, alcogel, or solvogel to form the gel 14 that contains drying agent dissolved in solvent.

In another exemplification, the gel 14 that contains drying agent dissolved in solvent can be prepared directly via a variety of methods, including a sol-gel process in which precursors, such as monomers, fine solid particles, or fibers, are dissolved, dispersed, or suspended in drying agent dissolved in a solvent and are caused to crosslink or interconnect (e.g., through ionic bonding, covalent bonding, hydrogen bonding, or other mechanisms) to form a 3-dimensional network of solids directly within the drying agent dissolved in the solvent medium. In this embodiment, no solvent exchange is required prior to drying the gel into a high-porosity material (e.g., at least 90 volume-% void fraction).

In other exemplifications, the gel 14 that contains drying agent dissolved in solvent can be prepared via a combination of direct and solvent-exchange methods in order to adjust the concentrations of the drying agent and the solvent from those concentrations conducive to direct gel formation to those concentrations conducive to drying the gel.

### Porous Material Preparation from Water-Containing Gel

FIG. 3 is a representation of an exemplary process that can be employed to produce the porous material 26 from a water-containing gel 36 that has pores filled with a drying agent dissolved in a solution of water and solvent. In the first stage of the process, a first purge gas 12 is introduced over the surface of a water-containing gel 36 that has pores filled with a drying agent dissolved in a solution of water and solvent. Evaporation of water and solvent from the surface of the water-containing gel 36 increases the water and solvent concentrations in the withdrawn purge gas 16 and reduces the amount of water and solvent located at the surface of the water-containing gel 36. Water and solvent from the interior of the water-containing gel 36 diffuse to the surface of the water-containing gel 36 to replenish the evaporated water and solvent and to reduce or minimize the water and solvent concentration gradients within the water-containing gel 36.

Water and solvent diffusion and evaporation result in a decrease in the concentration of water and solvent and an increase in the concentration of the drying agent within the water and solvent mixture contained in the pores of the gel. The concentration of the drying agent in the solution of water and solvent increases until the solution of water and solvent becomes saturated with the drying agent, at which time, the drying agent begins to precipitate or solidify within the pores of the gel. Evaporation of the water and solvent into the first purge gas 12 continues, typically until greater than about 60% by weight—e.g., greater than about 70% by weight, greater than about 80% by weight, greater than about 90% by weight, greater than about 95% by weight, or, in more-particular embodiments, at least about 98% by weight of the water and solvent has evaporated from the gel and typically until greater than about 60%—e.g., greater than about 70%, greater than about 80%, greater than about 90%, greater than about 95%, and, in more particular embodiments, at least about 98% of the drying agent has precipitated and solidified within the pores of the gel to yield a drying-agent-containing solid network 18.

While evaporating as much water and solvent as possible during the formation of the drying-agent-containing solid network can be advantageous, in other embodiments, it can be faster and more cost-effective to evaporate less of the water and solvent during the formation of the drying-agent-containing solid network and to evaporate more of the water and solvent in the second stage of the process. In these embodiments, evaporation of the water and solvent into the first purge gas 12 continues, typically until less than about 98% by weight—e.g., less than about 95% by weight, less than about 90% by weight, less than about 80% by weight, less than about 70% by weight, or in more-particular embodiments, at most about 60% by weight of water and solvent has evaporated from the gel.

Water and solvent evaporation from the water-containing gel 36 is conducted at a temperature below the melting-point temperature of the drying agent but at a temperature high enough to promote rapid diffusion and evaporation of the water and solvent from the gel. Water and solvent diffusion and evaporation are typically completed in less than about 48 hours—e.g., less than about 24 hours, less than about 12 hours, less than about 6 hours, less than about 2 hours, less than about 1 hour, less than about 30 minutes, less than about 10 minutes, or, in more-particular embodiments, at most about 2 minutes. The water and solvent evaporation temperature is typically greater than about 30° C. below the boiling-point temperature of the solvent—e.g., greater than about 15° C. below the boiling-point temperature of the solvent, greater than about the boiling-point temperature of the solvent, greater than about 15° C. above the boiling-point temperature of the solvent, greater than about 30° C. above the boiling-point temperature of the solvent, or, in more-particular embodiments, at least about 45° C. above the boiling point of the solvent. Depending upon the solvent, the water and solvent evaporation temperature is typically greater than about 70° C.—e.g., greater than about 80° C., greater than about 90° C., greater than about 100° C., greater than about 110° C., greater than about 130° C., greater than about 150° C., or, in more-particular embodiments, at least about 170° C.

Water and solvent diffusion and evaporation can be conducted at ambient pressure to avoid the use of a containment vessel for the water-containing gel 36 but may also be conducted at pressures above or below ambient pressure to affect the boiling-point temperatures of the water and solvent if desired.

Water and solvent diffusion and evaporation result in shrinkage of the water-containing gel 36, such that the volume of the drying-agent-containing solid network 18 is lower than that of the water-containing gel 36. The amount of shrinkage is related to the concentration of water and solvent in the water-containing gel 36, and the percentage of water and solvent evaporated from the gel prior to the formation of the drying-agent-containing solid network 18. Gel shrinkage is typically less than about 50 volume percent—e.g., less than about 35 volume percent, less than about 20 volume percent, less than about 10 volume percent, or, in more particular embodiments, at most 5 volume percent.

The energy required to effect water and solvent evaporation can be delivered to the water-containing gel 36 via a variety of mechanisms, including conduction from the surface upon which the water-containing gel 36 is supported, convection from the first purge gas 12, and/or radiation from the environment surrounding the water-containing gel 36. Microwave radiation can also be used to heat the gel and to effect water and solvent evaporation.

The first purge gas 12 can be any gas suitable for convecting thermal energy to the surface of the water-containing gel 36, for carrying away water and solvent from the surface of the water-containing gel 36, and from which the solvent can later be recovered from the withdrawn purge gas 16 for solvent reuse. The first purge gas 12 can flow over the water-containing gel 36 in any orientation, but flow in a direction perpendicular to the smallest dimension of the gel may be preferred to promote uniform removal of water and solvent from the gel surface. The first purge gas 12 can be flowed at any rate, but a flow rate such that the withdrawn purge gas 16 is nearly saturated in solvent vapor makes subsequent recovery of solvent from the withdrawn purge gas 16 easier.

The first purge gas 12 may comprise air, nitrogen, helium, argon, carbon dioxide, other common gases, or mixtures thereof. To avoid condensation and diffusion of water into the water-containing gel 36 and to reduce or minimize contamination of the withdrawn purge gas 16 with water, the water vapor content of the first purge gas 12 is typically less than about 2 volume percent—e.g., less than about 1 volume percent, less than about 0.5 volume percent, or, in more-particular embodiments, at most 0.2 volume percent.

To reduce or minimize losses of the drying agent to the first purge gas 12 that would reduce the amount of drying agent retained in the drying-agent-containing solid network 18, the first purge gas 12 can be pre-saturated with the drying agent such that the partial pressure of the drying agent in the first purge gas 12 is similar to the vapor pressure of the drying agent at the surface of the water-containing gel 36. Pre-saturation of the first purge gas 12 with the drying agent can be accomplished by flowing the first purge gas 12 through a vessel containing the drying agent at a temperature similar to that at which solvent and water diffusion and evaporation occur.

In another exemplification, saturation of the first purge gas 12 with the drying agent is realized by reducing the flow rate of the first purge gas 12, such that a small portion of drying agent from the water-containing gel 36 sublimes into the first purge gas 12 to saturate the first purge gas 12 and to inhibit additional sublimation of the drying agent from the water-containing gel 36.

In another exemplification, water and solvent are evaporated from the water-containing gel 36 in the absence of a purge gas. In this exemplification, the gel is retained in a chamber that maintains a saturated atmosphere of drying-agent vapor that arises from the sublimation of a small portion of drying agent from the water-containing gel 36 and inhibits additional sublimation of the drying agent from the water-containing gel 36. The vapor pressures of the water and solvent are substantially higher than that of the drying agent and can continuously evaporate from the water-containing gel 36, even in an unpurged chamber, if the vapor pressures of the water and solvent are greater than the partial pressures of water and solvent in the chamber. In this exemplification, the withdrawn purge gas 16 comprises primarily water and solvent vapor with a small amount of drying-agent vapor.

In yet another exemplification, loss of the drying agent from the water-containing gel 36 during water and solvent evaporation is reduced by locating the gel adjacent to a reservoir of drying agent so that a portion of the drying agent in the withdrawn purge gas 16 arises from the drying agent in the reservoir and a portion arises from the drying agent contained in the water-containing gel 36.

Referring again to FIG. 3, in the second stage of the process, a second purge gas 22 is introduced over the surface of a drying-agent-containing solid network 18 to form a drying gel 20; a drying-agent-containing purge gas 24; and ultimately, upon complete removal of the drying agent, a porous material 26. Sublimation of the solidified drying agent contained within the drying-agent-containing solid network 18 can have minimal effects on the solid pore structure of the drying-agent-containing solid network 18, as there is no liquid-gas meniscus present to exert capillary forces on the pore walls during drying agent removal. This stage of gel drying is similar in nature to what occurs during a conventional freeze-drying process; but the drying agent, temperature, pressure, and rate of drying agent removal may be substantially different than in a conventional freeze-drying process.

The energy required to effect drying-agent sublimation can be delivered to the drying gel 20 via a variety of mechanisms, including conduction from the surface upon which the drying gel 20 is supported, convection from the second purge gas 22, and/or radiation from the environment surrounding the drying gel 20. Microwave radiation can also be used to heat the drying gel 20 and to effect drying-agent sublimation.

The second purge gas 22 can be any gas suitable for convecting thermal energy to the surface of the drying gel 20, carrying away drying agent from the drying gel 20, and from which the drying agent can later be recovered from the drying-agent-containing purge gas 24 for drying-agent reuse. The second purge gas 22 can flow over the drying gel 20 in any orientation, but flow in a direction perpendicular to the smallest dimension of the drying gel 20 can be advantageous to promote uniform removal of drying agent from the drying gel 20. The second purge gas 22 can be flowed at any rate, but a flow rate such that the drying-agent-containing purge gas 24 is nearly saturated in drying-agent vapor makes subsequent recovery of drying agent from the drying-agent-containing purge gas 24 easier.

The second purge gas 22 can comprise air, nitrogen, helium, argon, carbon dioxide, other common gases, or mixtures thereof. To avoid condensation and diffusion of water into the drying gel 20 and to reduce or minimize contamination of the drying-agent-containing purge gas 24 with water, the water-vapor content of the second purge gas 22 is typically less than about 2 volume percent—e.g., less than about 1 volume percent, less than about 0.5 volume percent, or, in more-particular embodiments, at most 0.2 volume percent.

In an alternative embodiment, drying agent is sublimed from the drying gel 20 in the absence of a purge gas. In this embodiment, the drying gel 20 is retained in a loosely sealed chamber that has walls that are at a lower temperature than the drying gel 20. The drying agent sublimes from the drying gel 20 and deposits on the surface of the cooler chamber wall, thereby maintaining a drying-agent partial pressure within the chamber that is lower than the drying-agent vapor pressure at the surface of the drying gel 20 and facilitating the complete transfer of the drying agent from the drying gel 20 to the walls of the chamber in the absence of a purge gas.

The composition of the drying agent is dependent upon the solids composition of the water-containing gel 36, the composition of the solvent contained in the pores of the gel, the concentration of water within the pores of the gel, and the temperatures at which the gel is dried. The drying agent can exhibit specific physical characteristics. It is advantageous for the drying agent to possess a high melting-point temperature (e.g., above the temperature used to sublime drying agent from the drying-agent-containing solid network 18), to possess a low vapor pressure at the temperature used to evaporate water and solvent from the water-containing gel 36, to possess a high vapor pressure at the temperature used to sublime drying agent from the drying-agent-containing solid network 18, to be highly-soluble in the solution of water and solvent contained in the pores of the water-containing gel 36, to be miscible with water, and to form amorphous or weakly crystalline structures upon precipitation from the solution of water and solvent.

To ensure that the drying agent does not melt during the drying process and thereby subject the pores of the drying-agent-containing solid network 18 to undesirable capillary forces, the melting-point temperature of the drying agent is typically greater than about 30° C.—e.g., greater than about 70° C., greater than about 110° C., greater than about 150° C., or in more-particular embodiments, greater than about 190° C.

To reduce or minimize the loss of drying agent during water and solvent evaporation, the vapor pressure of the drying agent is typically less than about 20 kPa at 50° C.—e.g., less than about 5 kPa at 50° C., less than about 1 kPa at 50° C., less than about 0.2 kPa at 50° C., less than about 0.05kPa at 50° C., or in more-particular embodiments, less than about 0.01 kPa at 50° C.

To provide rapid removal of the drying agent during drying-agent sublimation, the vapor pressure of the drying agent is typically greater than about 0.01 kPa at 100° C.—e.g., greater than about 0.1 kPa at 100° C., greater than about 1 kPa at 100° C., greater than about 10 kPa at 100° C., or in more-particular embodiments, greater than about 100 kPa at 100° C. Drying agent sublimation is typically completed in less than about 48 hours—e.g., less than about 24 hours, less than about 12hours, less than about 6 hours, less than about 2 hours, less than about 1 hour, less than about 30minutes, less than about 10 minutes, or, in more-particular embodiments, at most about 2 minutes.

To reduce or minimize gel shrinkage during water and solvent evaporation, the solubility of the drying agent in the solution of water and solvent can be greater than about 30 weight percent—e.g., greater than about 40 weight percent, greater than about 50 weight percent, greater than about 60 weight percent, greater than about 70 weight percent, or in more-particular embodiments, even greater than 80 weight percent at 25° C.

In various exemplifications, the drying agent is camphene; 1,2,4,5-tetramethylbenzene; naphthalene; 2,2,3,3-tetramethylbutane; p-benzoquinone; dimethyl benzene-1,4-dicarboxylate; hexamethylbenzene; hydroquinone; camphor; tetrachloro-p-benzoquinone; hexamethylenetetramine; other organic compounds; or mixtures thereof.

The composition of the solvent within the water-containing gel 36 is dependent upon the solids composition of the gel, the composition of the drying agent, and the concentration of water within the water-containing gel 36. The solvent can exhibit specific physical characteristics. It is advantageous for the solvent to possess a low-boiling-point temperature (e.g., below the melting-point temperature of the drying agent), to possess a high vapor pressure at the temperature used to evaporate water and solvent from the gel, to exhibit high solvency for the drying agent, to exhibit no solvency for the solid component of the gel, to exhibit low surface tension, to exhibit high diffusivity within a solid matrix of the drying agent, and to promote the formation of amorphous or weakly crystalline structures upon drying-agent precipitation.

It is also advantageous for the solvent to have a higher boiling point (i.e., be less volatile) than water so that, during water and solvent evaporation from the water-containing gel 36, the water evaporates more quickly than the solvent. This quicker evaporation of water leads to greater depletion of water in the gel relative to depletion of solvent in the gel and reduces the concentration of water present in the residual solution of water and solvent that may be contained within the pores of the drying-agent-containing solid network. A reduced water concentration in the residual solution of water and solvent is advantageous as the surface tension of the solution decreases as the water concentration of the liquid decreases, which yields lower capillary pressures in the event that a liquid-gas interface forms within pores during drying-agent sublimation.

Preferential evaporation of water relative to solvent can also be achieved using a solvent with a lower boiling point than water if the solvent and water form a minimum boiling azeotrope.

To provide rapid evaporation of the water and solvent during the first stage of the process, the boiling-point temperature of the solvent is typically less than about 175° C.—e.g., less than about 150° C., less than about 125° C., less than about 100° C., less than about 75° C., or in more-particular embodiments, less than about 50° C.

To provide rapid evaporation of the water and solvent during the first stage of the drying process, the vapor pressure of the solvent is typically greater than about 0.01 kPa at 50° C.—e.g., greater than about 0.1 kPa at 50° C., greater than about 1 kPa at 50° C., greater than about 10 kPa at 50° C., or in more-particular embodiments, greater than about 50 kPa at 50° C.

To reduce or minimize gel shrinkage during solvent evaporation, the solubility of the drying agent in the solution of water and solvent can be greater than about 30 weight percent—e.g., greater than about 40 weight percent, greater than about 50 weight percent, greater than about 60 weight percent, greater than about 70 weight percent, or in more-particular embodiments, even greater than 80 weight percent at 25° C.

To reduce or minimize capillary forces on the pores of the gel during the process, the surface tension of the solution of water and solvent can be less than about 40 mN/m—e.g., less than about 30 mN/m, less than about 25 mN/m, less than about 20 mN/m), or in more-particular embodiments, even less than 18 mN/m at 25° C.

In various exemplifications, the solvent is an alcohol, such as methanol, ethanol, 1-propanol, 2-propanol, 1-butanol, 2-butanol, 2-methylbutan-2-ol, 2-methoxyethanol, 2-ethoxyethanol, 2-propoxyethanol, 2-isopropoxyethanol, 1-methoxy-2-propanol, 3-methoxy-1-propanol, 1-ethoxy-2-propanol, or 3-ethoxy-1-propanol; a ketone, such as acetone, butanone, 2-pentanone, or 3-pentanone; 1,1-dimethoxyethane; 1,2-dimethoxyethane; dimethylformamide; pyridine, acetonitrile; tetrahydrofuran; diethylether; methyl tert-butylether; or mixtures thereof.

In some embodiments, suitable solid materials that comprise the solid phase of the gel include silica, an ormosil, a biopolymer, a polysaccharide, a cellulose, an alginate, a carrageenan, an agarose, a starch, a chitin, a chitosan, a gelatin, a pectin, a phenolic polymer, a resorcinol-formaldehyde polymer, a polyimide, a polyamide, a polyurea, a polyurethane, a polyisocyanate, a polyisocyanurate, a polyacrylonitrile, or mixtures thereof.

In some embodiments, the gel can be reinforced with a fiber comprising glass; carbon; a biopolymer (e.g., cellulose, chitin, viscose, wool); a polymer (e.g., polyamide, polyethylene, polypropylene, polyurethane, polyacrylonitrile, polyethylene terephthalate, polybutylene terephthalate); a ceramic (e.g., silica, alumina, zirconia); or mixtures thereof.

### Water-Containing Gel Preparation

The preparation of a water-containing gel 36 having pores that are filled with a drying agent dissolved in a solution of water and solvent can be achieved in a variety of ways.

In one exemplification, the water-containing gel 36 that contains drying agent dissolved in a solution of water and solvent can be prepared via solvent exchange of a water-containing hydrogel, alcogel, or solvogel. The water-containing hydrogel, alcogel, or solvogel can be prepared via a variety of methods, including a sol-gel process in which precursors, such as monomers, fine solid particles, or fibers, are dissolved, dispersed, or suspended in a continuous liquid medium that contains water and are caused to crosslink or interconnect (e.g., through ionic bonding, covalent bonding, hydrogen bonding, or other mechanisms) to form a 3-dimensional network of solids within the liquid medium. The water-containing hydrogel, alcogel, or solvogel is typically prepared at greater than about 10° C.—e.g., greater than about 20° C., greater than about 40° C., greater than about 60° C., or in more-particular embodiments, greater than about 80° C. In this embodiment, the hydrogel, alcogel, or solvogel is brought into contact with a drying agent dissolved in a solvent or a drying agent dissolved in a sequence of solvents to effect replacement of typically greater than about 60%—e.g., greater than about 70%, greater than about 80%, greater than about 90%, greater than about 95%, or in more-particular embodiments, at least about 98% of the liquid in the hydrogel, alcogel, or solvogel with the drying agent and solvent via diffusive exchange.

While replacing as much liquid as possible during solvent exchange of the hydrogel, alcogel, or solvogel can be advantageous, in other embodiments, it can be faster and more cost-effective to replace less of the liquid during solvent exchange and to evaporate more of the liquid during the formation of the drying-agent-containing solid network and during sublimation of the drying agent. In these embodiments, less than typically about 98%—e.g., less than about 95%, less than about 90%, less than about 80%, less than about 70%, or in more-particular embodiments, at most about 60% of the liquid is replaced; and at least some of the remaining liquid is evaporated when the drying-agent-solution-containing gel is then heated.

In another exemplification, the water-containing gel 36 that contains drying agent dissolved in a solution of water and solvent can be prepared via solvent exchange of the water-containing hydrogel, alcogel, or solvogel with solvent to effect replacement of typically greater than about 60%—e.g., greater than about 70%, greater than about 80%, greater than about 90%, greater than about 95%, or in more-particular embodiments, at least about 98% of the liquid in the water-containing hydrogel, alcogel, or solvogel followed by dispersion of solid drying agent on the surface of the exchanged hydrogel, alcogel, or solvogel. In particular embodiments, less than typically about 98%—e.g., less than about 95%, less than about 90%, less than about 80%, less than about 70%, or in more-particular embodiments, at most about 60% of the liquid is replaced, followed by dispersion of solid drying agent on the surface of the exchanged hydrogel, alcogel, or solvogel. The solid drying agent dissolves and diffuses into the solution of water and solvent contained in the pores of the exchanged hydrogel, alcogel, or solvogel to form the water-containing gel 36 that contains drying agent dissolved in a solution of water and solvent.

In another exemplification, the water-containing gel 36 that contains drying agent dissolved in a solution of water and solvent can be prepared directly via a variety of methods, including a sol-gel process in which precursors such as monomers, fine solid particles, or fibers, dissolved, dispersed, or suspended in a solution of drying agent dissolved in a continuous liquid medium of water and solvent are caused to crosslink or interconnect (e.g., through ionic bonding, covalent bonding, hydrogen bonding, or other mechanisms) to form a 3-dimensional network of solids directly within the drying agent dissolved in the water and solvent medium. In this embodiment, no solvent exchange is required prior to drying the gel into a high-porosity material (e.g., at least 90 volume-% void fraction).

In other exemplifications, the water-containing gel 36 that contains drying agent dissolved in a solution of water and solvent can be prepared via a combination of direct and solvent exchange methods in order to adjust the concentrations of the drying agent, water, and solvent from those concentrations conducive to direct gel formation to those concentrations conducive to drying the gel.

The concentration of water in the pores of the water-containing gel 36 is typically greater than about 1 weight percent—e.g., greater than about 2 weight percent, greater than about 5 weight percent, greater than about 10 weight percent, greater than about 20 weight percent, greater than about 30 weight percent, or in more-particular embodiments, even greater than 40 weight percent relative to the weight of the water-containing gel. A water-containing gel 36 that contains a lower concentration of water is typically easier to dry than a gel containing a high concentration of water, because less water is evaporated during the drying process. A water-containing gel 36 that contains a higher concentration of water is typically easier to prepare than a gel containing a low concentration of water because less solvent exchange may be required to produce the gel.

### Porous Material Properties

Rather than being constrained by the dimensions of a pressure vessel, the dimensions of the porous material 26 are instead constrained by the dimensions of heating ovens used to evaporate solvent and water, if present, and to sublime drying agent. Lateral dimensions of a sheet of porous material are typically greater than about 0.2 m—e.g., greater than about 0.5 m, greater than about 1 m, greater than about 2 m, or in more particular embodiments, greater than about 5 m. The thickness of a sheet of porous material is typically greater than about 0.001 m—e.g., greater than about 0.005 m, greater than about 0.01 m, greater than about 0.02 m, greater than about 0.05 m, or in more particular embodiments, greater than about 0.1 m.

The porous material 26 may also be prepared in bead or granular form by forming hydrogel, alcogel, or solvogel beads or granules that have pores filled with a drying agent dissolved in a solvent and water, if present, then conducting the drying process. In these exemplifications, dimensions of the beads are typically less than about 0.01 m—e.g., less than about 0.005 m, less than about 0.002 m, less than about 0.001 m, or in more particular embodiments, less than about 0.0005 m. The use of gels with smaller dimensions reduces the distance that solvent and water, if present, or drying agent must diffuse and results in a faster solvent exchange and drying process.

The porous material 26 can have a density less than about 0.5 g/cm³—e.g., less than about 0.2 g/cm³, less than about 0.1 g/cm³, less than about 0.05 g/cm³, less than about 0.02 g/cm³, or even less than about 0.01 g/cm³.

The porous material 26 can have an average pore dimension of less than about 1 micron—e.g., less than about 0.3 microns, less than about 0.1 microns, less than about 0.03 microns, less than about 0.01 microns, less than about 0.003 microns, or even less than about 0.001 microns.

The porous material 26 can have a surface area of greater than about 20 m²/g—e.g., greater than about 50 m²/g, greater than about 100 m²/g, greater than about 300 m²/g, greater than about 500 m²/g, or even greater than about 1,000 m²/g.

The porous material 26 can have a thermal conductivity less than about 35 mW/mK—e.g., less than about 30 mW/mK, less than about 25 mW/mK, less than about 20 mW/mK, or even less than about 15 mW/mK at 25° C.

### Continuous Preparation of Porous Material

Referring to FIG. 4, the porous material 26 can be produced via a continuous processing method. Materials for gel formation and drying (e.g., solvents 40, precursors 42, crosslinkers and catalysts 44, and drying agent 46) are blended in a mixer 48 and heated in a preheater 50; and then the mixture is cast onto a conveyor 52 located within an oven 54. The oven 54 is segregated into three separate zones 58, 60, and 62 that provide independent control of temperature and environment. The cast mixture 56 is retained in the first zone 58 for a time and at a temperature sufficient to induce gelation of the cast mixture 56 into a gel 14. The gel 14 is conveyed into the second zone 60, wherein it is exposed to a first purge gas 12 for a time and a temperature sufficient to evaporate a substantial portion of the solvent from the gel 14 into a solvent-enriched purge gas 16 (that is withdrawn from the oven 54) to form a drying-agent-containing solid network 18. The drying-agent-containing solid network 18 is conveyed into the third zone 62, wherein it is exposed to a second purge gas 22 for a time and a temperature sufficient to evaporate and sublime the remainder of the volatile components within the drying-agent-containing solid network 18 into a drying-agent-containing purge gas 24 to form a porous material 26.

The solvent- and drying-agent-enriched purges are cooled in a first heat exchanger 64 and in a second heat exchanger 66 to form a condensed-solvent-and-drying-agent stream 68 that can be recycled to the mixer 48 and a solvent-and-drying agent-depleted stream 70 that can be used to supply the first and second purge gases 12 and 22 to the oven 54.

The following examples illustrate methods of preparing high-porosity materials.

### EXEMPLIFICATIONS

### Example 1: Preparation of Cellulose Via Camphor/Acetone Solution

66.5 g of a 1.2-weight-percent solution of nanofibrillated cellulose [2,2,6,6-tetramethylpiperidine-1-oxyl-oxidized cellulose nanofibers (TEMPO-CNF cellulose nanofibers from Forest Products Laboratory)] in water was mixed with 0.56 g of a 20-weight-percent aqueous solution of polyethyleneimine (800 Da, from Sigma-Aldrich) and 0.22 g epichlorohydrin (from Sigma-Aldrich) for 15 minutes at ambient temperature. The mixture was sealed into an 83-mm-diameter polypropylene jar and heated at 55° C. for 18 hours to form a gel. Following cooling to ambient temperature, the gel was removed from the jar and transferred to a solvent-exchange bath containing acetone.

The volume of the first solvent-exchange bath was approximately 8 times the volume of the gel. The gel was soaked in the solvent-exchange bath for 2 days, wherein the solvent was replaced with fresh acetone once per day to yield a gel in which the acetone solution in the pores of the gel contained less than 2-weight-percent water.

The gel was removed from the solvent-exchange bath, transferred to another container containing 123 g of camphor, and placed on an orbital shaker for 34 hours.

The resulting camphor/acetone-containing gel was transferred into a loosely sealed container within a 120° C. oven for 39 hours to evaporate liquids from the gel. The resulting camphor-containing solid network was transferred into a slightly open container in a 120° C. oven for an additional 3 days to sublime camphor from the solid network.

The resulting cellulose gel is a high-porosity material with a bulk density of 0.03 g/cm³. When the high-porosity material is compressed to a bulk density of 0.05 g/cc, the high-porosity material exhibits a thermal conductivity of 23.9 mW/mK at 25° C.

### Example 2: Preparation of Cellulose Via Camphor/1-Propanol Solution

141.1 g of a 1.2-weight-percent solution of nanofibrillated cellulose [2,2,6,6-tetramethylpiperidine-1-oxyl-oxidized cellulose nanofibers (TEMPO-CNF cellulose nanofibers from Forest Products Laboratory)] in water was mixed with 1.18 g of a 20-weight-percent aqueous solution of polyethyleneimine (800 Da, from Sigma-Aldrich) and 0.49 g of epichlorohydrin (from Sigma-Aldrich) for 15 minutes at ambient temperature. The mixture was sealed into a 14-cm-by-11-cm polystyrene tray and heated at 55° C. for 18 hours to form a gel. Following cooling to ambient temperature, a 47-mm-diameter disk was punched from the gel and transferred to a solvent-exchange bath containing 1-propanol.

The volume of the first solvent-exchange bath was approximately 6 times the volume of the gel. The gel was soaked in the solvent-exchange bath for 2 days, wherein the solvent was replaced with fresh 1-propanol twice per day to yield a gel in which the 1-propanol solution in the pores of the gel contained less than 0.2-weight-percent water.

The gel was removed from the solvent-exchange bath; transferred to another solvent-exchange bath, including 21 g of camphor and 2 g of 1-propanol; and placed on an orbital shaker for 2 days.

The resulting camphor/1-propanol-containing gel was transferred into a loosely sealed container into which 8 cm³/min air was introduced for 27 hours within a 120° C. oven to evaporate liquids and sublime camphor from the gel.

The resulting cellulose gel is a high-porosity material with a bulk density of 0.05 g/cm³.

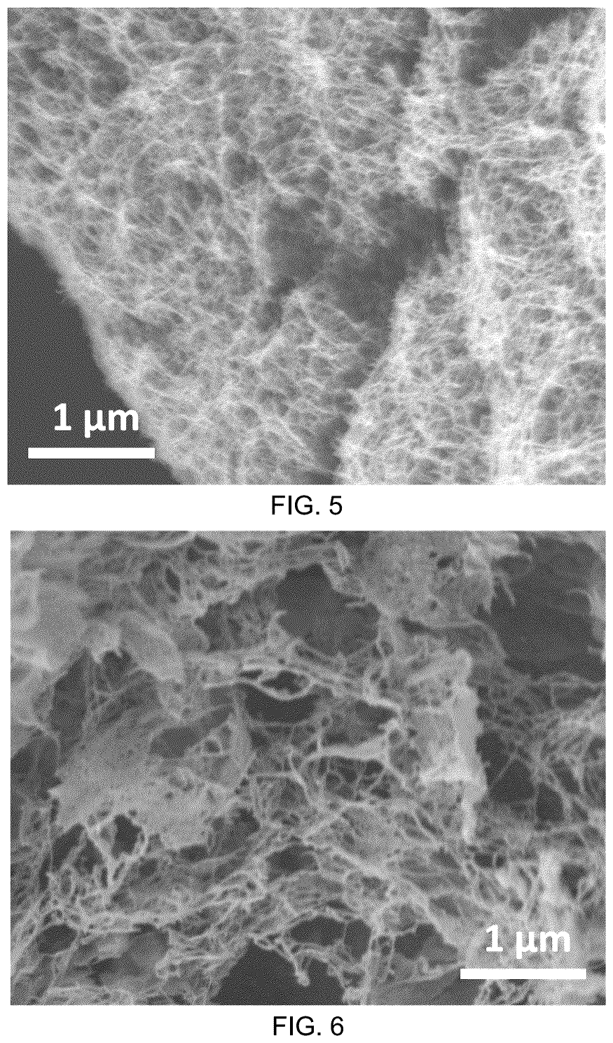

FIG. 5 represents an image of the cross-section of the dried cellulose gel. Visible in the image are fibers with an average diameter of less than approximately 0.1 microns, defining pores that range in size from less than approximately 0.1 microns to approximately 1 micron.

### Example 3: Preparation of Cellulose Via Camphor/1-Propanol Solution

288 g of a 1.2-weight-percent solution of nanofibrillated cellulose [2,2,6,6-tetramethylpiperidine-1-oxyl-oxidized cellulose nanofibers (TEMPO-CNF cellulose nanofibers from Forest Products Laboratory)] in water was mixed with 2.52 g of a 20-weight-percent aqueous solution of polyethyleneimine (800 Da, from Sigma-Aldrich) and 0.98 g of epichlorohydrin (from Sigma-Aldrich) for 15 minutes at ambient temperature. The mixture was sealed into an 8-inch-diameter polypropylene jar and heated at 55° C. for 18 hours to form a gel. Following cooling to ambient temperature, the gel was removed from the jar and transferred to a solvent-exchange bath containing 1-propanol.

The volume of the first solvent-exchange bath was approximately 0.6 times the volume of the gel. The gel was soaked in the solvent-exchange bath for 14 days, with the solvent replaced with fresh 1-propanol twice per day, to yield a gel in which the 1-propanol solution in the pores of the gel contained less than 0.5-weight-percent water.

The gel was removed from the solvent-exchange bath and transferred to another solvent-exchange bath, including 127 g of camphor and 85 g of 1-propanol. After 24 hours, the gel was transferred to another solvent-exchange bath, including 246 g of camphor and 16 g of 1-propanol at 33° C. After 10 days, 60 g of additional camphor was added to the solvent-exchange bath at 37° C.

The resulting camphor/1-propanol-containing gel was transferred into a loosely sealed container within a 110° C. oven for 8 days to evaporate solvent from the gel. The resulting camphor-containing solid network was transferred into a slightly open container in a 110° C. oven for an additional 4 days to sublime camphor from the solid network.

The resulting cellulose gel is a high-porosity material with a bulk density of 0.07 g/cm³. The material has a surface area of 305 m²/g. When the high-porosity material is compressed to a bulk density of 0.12 g/cc, the high-porosity material exhibits a thermal conductivity of 20.6 mW/mK at 25° C.

### Example 4: Preparation of Cellulose Via Camphor/1-Propanol Solution

140.3 g of 1.2 weight-percent solution of nanofibrillated cellulose [2,2,6,6-tetramethylpiperidine-1-oxyl-oxidized cellulose nanofibers (TEMPO-CNF cellulose nanofibers from Forest Products Laboratory)] in water was mixed with 1.16 g of 20-weight-percent aqueous solution of polyethyleneimine (800 Da, from Sigma-Aldrich) and 0.46 g of epichlorohydrin (from Sigma-Aldrich) for 15 minutes at ambient temperature. The mixture was sealed into a 14-cm-by-11-cm polystyrene tray and heated at 55° C. for 18 hours to form a gel. Following cooling to ambient temperature, a 62-mm-diameter disk was punched from the gel and transferred to a solvent-exchange bath containing 1-propanol.

The volume of the first solvent-exchange bath was approximately 3 times the volume of the gel. The gel was soaked in the solvent-exchange bath for 4 days, with the solvent replaced with fresh 1-propanol once per day, to yield a gel in which the 1-propanol solution in the pores of the gel contained less than 2-weight-percent water.

The gel was removed from the solvent-exchange bath; transferred to another solvent-exchange bath, including 36 g of camphor and 3 g of 1-propanol; and placed on an orbital shaker for 2 days.

The resulting camphor/1-propanol-containing gel was transferred into a loosely sealed container within a 125° C. oven for 2 days to evaporate solvent from the gel. The resulting camphor-containing solid network was transferred into a slightly open container in a 125° C. oven for an additional 2 days to sublime camphor from the solid network.

The resulting cellulose gel is a high-porosity material with a bulk density of 0.04 g/cm³. When compressed to a bulk density of 0.09 g/cc, the high-porosity material exhibits a thermal conductivity of 21.4 mW/mK at 25° C.

FIG. 6 represents an image of the cross-section of the dried cellulose gel. Visible in the image are fibers with an average diameter of less than approximately 0.1 microns, defining pores that range in size from less than approximately 0.1 microns to approximately 1 micron.

### Example 5: Preparation of Cellulose Via Camphor/Water/1-Propanol Solution

60.0 g of 1.2-weight-percent solution of nanofibrillated cellulose [2,2,6,6-tetramethylpiperidine-1-oxyl-oxidized cellulose nanofibers (TEMPO-CNF cellulose nanofibers from Forest Products Laboratory)] in water was mixed with 0.51 g of 20-weight-percent aqueous solution of polyethyleneimine (800 Da, from Sigma-Aldrich) and 0.20 g of epichlorohydrin (from Sigma-Aldrich) for 15 minutes at ambient temperature. The mixture was sealed into an 83-mm-diameter polypropylene jar and heated at 55° C. for 18 hours to form a gel. Following cooling to ambient temperature, the gel was removed from the jar and transferred to a solvent-exchange bath containing 1-propanol.

The volume of the first solvent-exchange bath was approximately 3 times the volume of the gel. The gel was soaked in the solvent-exchange bath for 2 days, with the solvent replaced with fresh 1-propanol once per day, to yield a gel in which the 1-propanol solution in the pores of the gel contained approximately 11-weight-percent water.

The gel was removed from the solvent-exchange bath; transferred to another solvent-exchange bath, including 146 g of camphor, 20 g of water, and 64 g of 1-propanol; and stirred for 2 days.

The resulting camphor/water/1-propanol-containing gel was transferred into a loosely sealed container within a 125° C. oven for 2 days to evaporate water and solvent from the gel. The resulting camphor-containing solid network was transferred into a slightly open container in a 125° C. oven for an additional 2 days to sublime camphor from the solid network.

The resulting cellulose gel is a high-porosity material with a bulk density of 0.09 g/cm³.

### Example 6: Preparation of Cellulose Via Camphor/Water/Acetone Solution

70.2 g of 1.1-weight-percent solution of nanofibrillated cellulose [2,2,6,6-tetramethylpiperidine-1-oxyl-oxidized cellulose nanofibers (TEMPO-CNF cellulose nanofibers from Forest Products Laboratory)] in water was mixed with 0.56 g of 20-weight-percent aqueous solution of polyethyleneimine (800 Da, from Sigma-Aldrich) and 0.23 g of epichlorohydrin (from Sigma-Aldrich) for 15 minutes at ambient temperature. The mixture was sealed into an 83-mm-diameter polypropylene jar and heated at 55° C. for 18 hours to form a gel. Following cooling to ambient temperature, the gel was removed from the jar and transferred to a solvent-exchange bath containing acetone.

The volume of the first solvent-exchange bath was approximately 4 times the volume of the gel. The gel was soaked in the solvent-exchange bath for 2 days, with the solvent replaced with fresh acetone once per day, to yield a gel in which the acetone solution in the pores of the gel contained approximately 4 weight-percent water.

The gel was removed from the solvent-exchange bath; transferred to another solvent-exchange bath, including 80 g of camphor and 3.4 g of water; and stirred for 1 day.

The resulting camphor/water/acetone-containing gel was transferred into a loosely sealed container within a 160° C. oven for 3.5 hours to evaporate water and solvent from the gel. The resulting camphor-containing solid network was transferred into a slightly open container in a 160° C. oven for an additional 1 hour to sublime camphor from the solid network.

The resulting cellulose gel is a high-porosity material with a bulk density of 0.07 g/cm³ and exhibits a thermal conductivity of 25.8 mW/mK at 25° C.

### Example 7: Preparation of Cellulose Via Camphor/Water/1-Methoxy-2-Propanol Solution

140.3 g of 1.2-weight-percent solution of nanofibrillated cellulose [2,2,6,6-tetramethylpiperidine-1-oxyl-oxidized cellulose nanofibers (TEMPO-CNF cellulose nanofibers from Forest Products Laboratory)] in water was mixed with 1.16 g of 20-weight-percent aqueous solution of polyethyleneimine (800 Da, from Sigma-Aldrich) and 0.46 g of epichlorohydrin (from Sigma-Aldrich) for 15 minutes at ambient temperature. The mixture was sealed into a 14-cm-by-11-cm polystyrene tray and heated at 55° C. for 18 hours to form a gel. Following cooling to ambient temperature, a 47-mm-diameter disk was punched from the gel and transferred to a solvent-exchange bath containing 1-methoxy-2-propanol.

The volume of the first solvent-exchange bath was approximately 2 times the volume of the gel. The gel was soaked in the solvent-exchange bath for 6 days, with the solvent replaced with fresh 1-methoxy-2-propanol once per day, to yield a gel in which the 1-methoxy-2-propanol solution in the pores of the gel contained less than 0.2-weight-percent water.

The gel was removed from the solvent-exchange bath; transferred to another solvent-exchange bath, including 24 g of camphor, 2 g of water, and 5 g of 1-methoxy-2-propanol; and placed on an orbital shaker for 1 day.

The resulting camphor/water/1-methoxy-2-propanol-containing gel was transferred into a loosely sealed container within a 120° C. oven for 5 days to evaporate water and solvent from the gel. The resulting camphor-containing solid network was transferred into a slightly open container in a 120° C. oven for an additional 24 hours to sublime camphor from the solid network.

The resulting cellulose gel is a high-porosity material with a bulk density of 0.09 g/cm³.

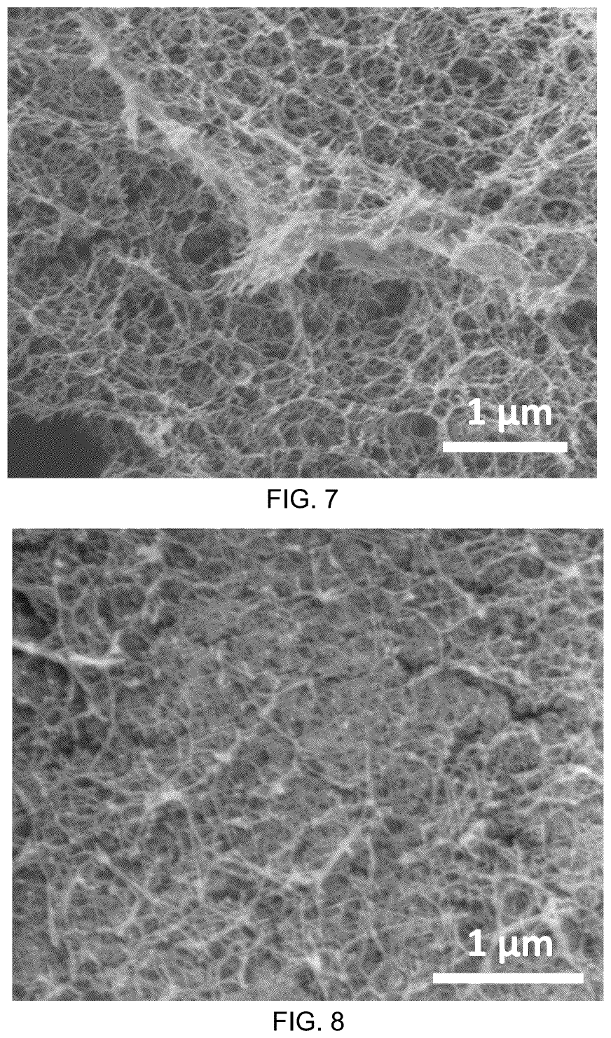

FIG. 7 represents an image of the cross-section of the dried cellulose gel. Visible in the image are fibers with an average diameter of less than approximately 0.1 microns, defining pores that range in size from less than approximately 0.1 microns to approximately 0.4 microns.

### Example 8: Preparation of Cellulose Via Water/Hexamethylenetetramine Solution

136.9 g of 1.2-weight-percent solution of nanofibrillated cellulose [2,2,6,6-tetramethylpiperidine-1-oxyl-oxidized cellulose nanofibers (TEMPO-CNF cellulose nanofibers from Forest Products Laboratory)] in water was mixed with 1.20 g of 20-weight-percent aqueous solution of polyethyleneimine (800 Da, from Sigma-Aldrich) and 0.58 g of epichlorohydrin (from Sigma-Aldrich) for 15 minutes at ambient temperature. The mixture was sealed into a 14-cm-by-11-cm polystyrene tray and heated at 55° C. for 18 hours to form a gel. Following cooling to ambient temperature, a 47-mm-diameter disk was punched from the gel, transferred to a solvent-exchange bath including 10 g of water and 22 g of hexamethylenetretramine, and placed on an orbital shaker for 2 days.

The resulting water/hexamethylenetetramine-containing gel was transferred into a loosely sealed container into which 8 cm³/min air was introduced for 3 days within a 150° C. oven to evaporate water and sublime hexamethylenetetramine from the gel.

The resulting cellulose gel is a high-porosity material with a bulk density of 0.02 g/cm³.

### Example 9: Preparation of Cellulose Via Tert-Butanol Freeze Drying

40 g of 1.3-weight-percent solution of nanofibrillated cellulose [2,2,6,6-tetramethylpiperidine-1-oxyl-oxidized cellulose nanofibers (TEMPO-CNF, from Forest Products Laboratory)] in water was mixed with 1.14 g of 10.5-weight-percent aqueous solution of polyethyleneimine (800 Da, from Sigma-Aldrich) and 0.18 g of epichlorohydrin (from Sigma-Aldrich) for 20 minutes at ambient temperature. The mixture was sealed into a 4-ounce plastic jar and heated at 55° C. for 18 hours to form a gel. Following cooling to ambient temperature, the gel was removed from the jar and transferred to a solvent-exchange bath containing tert-butanol.

The volume of the solvent-exchange bath was approximately 4 times the volume of the gel. The gel was soaked in the solvent-exchange bath for 5 days, with the solvent replaced with fresh tert-butanol twice per day, to yield a gel in which the tert-butanol solution in the pores of the gel contained less than 0.2-weight-percent water. The solvent-exchanged gel was cooled to less than 5° C. for 2 hours and then freeze-dried at ambient temperature and a vacuum pressure of less than 50mtorr for 24 hours to remove the solidified tert-butanol from the pores.

The resulting tert-butanol-freeze-dried cellulose gel is a high-porosity material with a bulk density of 0.02 g/cm³. When compressed to a bulk density of 0.05 g/cc, the high-porosity material exhibits a thermal conductivity of 25.4 mW/mK at 25° C. The material has a surface area of 313 m²/g.

FIG. 8 represents an image of the cross-section of the tert-butanol-freeze-dried cellulose gel. Visible in the image are fibers with an average diameter of less than approximately 0.1 micron, defining pores that range in size from less than approximately 0.1 microns to approximately 0.3 microns.

### Example 10: Preparation of Silica Via Camphor/1-Propanol Solution

A solution including 13.2 g of tetraethylorthosilicate (from MilliporeSigma), 0.63 mL of hydrochloric acid (1 M, from Thermo Scientific Chemicals), 3.4 mL of water, and 50 mL of ethanol (from MilliporeSigma) was stirred at room temperature for 2 hours to partially hydrolyze the tetraethylorthosilicate.

0.4 mL of NH₄OH (5 M, from MilliporeSigma) dissolved in 8 mL of ethanol was added to the partially hydrolyzed tetraethylorthosilicate solution. The mixture was stirred for 2 minutes and was then poured over a 0.7-g polyester fiber mat (POLY-FIL polyester fiber fill with a density of 0.009 g/cc, from Fairfield Processing Corporation) in an 8-oz plastic jar. The sealed jar was heated at 55° C. for 18 hours to form a gel. 20 mL of ethanol (from MilliporeSigma) was added to the gel, which was aged an additional 18 h at 55° C. and then transferred to a solvent-exchange bath containing 1-propanol.

The volume of the first solvent-exchange bath was approximately 2 times the volume of the gel. The gel was soaked in the solvent-exchange bath for 4 days, with the solvent replaced with fresh 1-propanol once per day, to yield a gel in which the 1-propanol solution in the pores of the gel contained less than 2-weight-percent ethanol.

The gel was removed from the solvent-exchange bath, transferred to another container containing 100 g of camphor, and placed on an orbital shaker for 5 days.

The resulting camphor/1-propanol-containing gel was transferred into a loosely sealed container within a 130° C. oven for 7 days to evaporate solvent from the gel. The resulting camphor-containing solid network was transferred into a slightly open container in a 130° C. oven for an additional 48 hours to sublime camphor from the solid network.

The resulting reinforced silica gel is a high-porosity material with a bulk density of 0.17 g/cm³.

The use of these methods for producing high-porosity materials can offer many advantages over the use of previously known methods for the production of aerogels, cryogels, xerogels, and similar porous materials.

An advantage provided by embodiments of the method is that all of the processing can be conducted at ambient pressure. The dimensions of the high-porosity material are thus not constrained by the relatively small diameter of a typical pressure containment vessel. Production of high-porosity materials at ambient pressure can also be less expensive than conventional cryogel or aerogel drying processes, as no vacuum or high-pressure equipment is required.

Another advantage provided by embodiments of the method is that all of the processing can be conducted at ambient or above ambient temperature, thereby avoiding energy- and cost-intensive cooling steps required for cryogel production.

Another advantage provided by embodiments of the method is that water contained in the gel can be removed as a part of the drying process without having to subject the gel to time-intensive and solvent-intensive solvent exchange processes.

Another advantage provided by embodiments of the method is that the drying process can be conducted quickly, being limited only by the time required to evaporate solvent and water, if present, and to sublime drying agent from the gel. The drying temperature can be increased to accelerate the removal of solvent; and water, if present; and drying agent from the gel, as long as the solid material comprising the dried gel is thermally stable at the increased temperature.

Another advantage provided by exemplifications of the method is that the solvent and drying agent can be readily recovered and separated by condensation and deposition and then reused to make additional high-porosity materials.

Yet another advantage provided by exemplifications of the method is that the high-porosity materials can be produced in a continuous process.

In describing embodiments of the invention, specific terminology is used for the sake of clarity. For purposes of description, each specific term is intended to at least include all technical and functional equivalents that operate in a similar manner to accomplish a similar purpose. Additionally, in some instances where a particular embodiment of the invention includes a plurality of system elements or method steps, those elements or steps may be replaced with a single element or step; likewise, a single element or step may be replaced with a plurality of elements or steps that serve the same purpose. Further, where parameters for various properties are specified herein for embodiments of the invention, those parameters can be adjusted up or down by 1/100^{th}, 1/50^{th}, 1/20^{th}, 1/10^{th}, ⅕^{th}, ⅓^{rd}, ½, ⅔^{rd}, ¾^{th}, ⅘^{th}, 9/10^{th}, 19/20^{th}, 49/50^{th}, 99/100^{th}, etc. (or up by a factor of 1, 2, 3, 4, 5, 6, 8, 10, 20, 50, 100, etc.), or by rounded-off approximations thereof, unless otherwise specified. Moreover, while this invention has been shown and described with references to particular embodiments thereof, those skilled in the art will understand that various substitutions and alterations in form and details may be made therein without departing from the scope of the invention. Further still, other aspects, functions, and advantages are also within the scope of the invention; and all embodiments of the invention need not necessarily achieve all of the advantages or possess all of the characteristics described above. Additionally, steps, elements, and features discussed herein in connection with one embodiment can likewise be used in conjunction with other embodiments. The contents of all references, including reference texts, journal articles, patents, patent applications, etc., cited throughout this application are hereby incorporated by reference in their entirety. All appropriate combinations of embodiments, features, characterizations, components, and methods of those references and the present disclosure may be selected for inclusion in embodiments of the invention. Still further, the components and methods identified in the Background section are integral to this disclosure and can be used in conjunction with or substituted for components and methods described elsewhere in the disclosure within the scope of the invention.

What is claimed is:

1. A method for manufacturing a porous material, the method comprising:
forming a drying-agent-solution-containing gel, comprising a solvent, a drying agent dissolved in the solvent, and a porous three-dimensional solid network contained in the solvent, wherein the drying-agent-solution-containing gel is formed by one of the following methods:
(a) introducing a gel comprising a liquid containing the porous three-dimensional solid network as an initial charge and then replacing at least some of the liquid in pores of the porous three-dimensional solid network with the drying agent dissolved in the solvent to form the drying-agent-solution-containing gel, or
(b) introducing gel precursors, the solvent, and the drying agent as an initial charge and initiating a crosslinking of the gel precursors into the porous three-dimensional solid network to form the drying-agent-solution-containing gel; then
heating the drying-agent-solution-containing gel to evaporate at least some of the solvent and to form a drying-agent-containing solid network; and then
heating the drying-agent-containing solid network to sublime the drying agent and to form a porous material.

2. The method of claim 1, wherein the solid network comprises silica, an ormosil, a cellulose, an alginate, a carrageenan, an agarose, a starch, a chitin, a chitosan, a gelatin, a pectin, a phenolic polymer, a resorcinol-formaldehyde polymer, a polyimide, a polyamide, a polyurea, a polyurethane, a polyisocyanate, a polyisocyanurate, a polyacrylonitrile, or a mixture of a plurality of these solids.

3. The method of claim 1, wherein the drying-agent-solution-containing gel is formed by (a) introducing the gel comprising the liquid containing the porous three-dimensional solid network as the initial charge and then replacing at least some of the liquid in the pores of the porous three-dimensional solid network with the drying agent dissolved in the solvent to form the drying-agent-solution-containing gel.

4. The method of claim 3, wherein the liquid is water, an alcohol, or a mixture thereof.

5. The method of claim 3, wherein the liquid is replaced via diffusive exchange with the drying agent dissolved in the solvent at a temperature below the melting point temperature of the drying agent.

6. The method of claim 3, wherein less than 98% by weight of the liquid is replaced, and wherein the heating of the drying-agent-solution-containing gel also evaporates at least some of the liquid remaining in the drying-agent-solution-containing gel.

7. The method of claim 3, wherein the liquid comprises water, wherein some of the water remains in the pores of the porous three-dimensional solid network, and wherein the remaining water is present in the pores at a concentration greater than 2% by weight of the drying-agent-solution-containing gel.

8. The method of claim 3, wherein the liquid comprises water, and wherein less than 98% by weight of the combined water and solvent is evaporated to form the drying-agent-containing solid network, and wherein the drying-agent-containing solid network is heated to also evaporate remaining water and solvent.

9. The method of claim 1, wherein the drying-agent-solution-containing gel is formed by (b) introducing the gel precursors, the solvent, and the drying agent as the initial charge and initiating the crosslinking of the gel precursors into the porous three-dimensional solid network to form the drying-agent-solution-containing gel.

10. The method of claim 9, wherein the drying-agent-containing solid network is heated to a temperature equal to or greater than the temperature at which the drying-agent-solution-containing gel is formed.

11. The method of claim 9, wherein the initial charge further comprises water, and wherein the water remains in the drying-agent-solution-containing gel at a concentration greater than 2% by weight of the drying-agent-solution-containing gel.

12. The method of claim 9, wherein the initial charge further comprises water, and wherein less than 98% by weight of the combined water and solvent is evaporated to form the drying-agent-containing solid network, and wherein the drying-agent-containing solid network is heated to also evaporate remaining water and solvent.

13. The method of claim 1, wherein less than 98% by weight of the solvent is evaporated to form the drying-agent-containing solid network, and wherein the heating of the drying-agent-containing solid network also evaporates solvent remaining in the drying-agent-containing solid network.

14. The method of claim 1, wherein the drying-agent-containing solid network is heated for less than 1 hour.

15. The method of claim 1, wherein the drying agent is camphene; 1,2,4,5-tetramethylbenzene; naphthalene; 2,2,3,3-tetramethylbutane; p-benzoquinone; dimethyl benzene-1,4-dicarboxylate; hexamethylbenzene; hydroquinone; camphor; tetrachloro-p-benzoquinone; hexamethylenetetramine; or a mixture of a plurality of these drying agents.

16. The method of claim 1, wherein the drying agent consists essentially of camphor.

17. The method of claim 1, wherein the solvent is methanol; ethanol; 1-propanol; 2-propanol; 1-butanol; 2-butanol; 2-methylbutan-2-ol; acetone; butanone; 2-pentanone; 3-pentanone; 2-methoxyethanol; 2-ethoxyethanol; 2-propoxyethanol; 2-isopropoxyethanol; 1-methoxy-2-propanol; 3-methoxy-1-propanol; 1-ethoxy-2-propanol, 3-ethoxy-1-propanol; 1,1-dimethoxyethane; 1,2-dimethoxyethane; dimethylformamide; pyridine; acetonitrile; tetrahydrofuran; diethylether; methyl tert-butylether; or a mixture of a plurality of these solvents.

18. The method of claim 1, wherein the heating of the drying-agent-solution-containing gel evaporates the solvent at a temperature greater than or equal to 80° C.

19. The method of claim 1, wherein the heating of the drying-agent-containing solid network sublimes the drying agent at a temperature greater than or equal to 90° C.

20. The method of claim 1, wherein the solvent is evaporated into an environment saturated with the drying agent in vapor form.

21. The method of claim 1, wherein the solvent, after being evaporated, is recovered for reuse by condensation, and wherein the drying agent, after sublimation, is recovered for reuse by deposition.

22. The method of claim 1, wherein the porous material has at least one dimension greater than or equal to 1 m.

23. The method of claim 1, wherein the porous material has an average pore dimension of less than 1 micron.

24. The method of claim 1, wherein the porous material has a bulk density between 0.02 and 0.2 g/cm³.

25. The method of claim 1, wherein the porous material has a thermal conductivity of less than 30 mW/mK.
